(19) United States
(12) Patent Application Publication
(10) Pub. No.: US 2015/0063589 A1
(43) Pub. Date: Mar. 5, 2015

(54) METHOD, APPARATUS, AND MANUFACTURE OF ADAPTIVE NULL BEAMFORMING FOR A TWO-MICROPHONE ARRAY

(71) Applicant: CSR TECHNOLOGY INC., Sunnyvale, CA (US)

(72) Inventors: Tao Yu, Rochester Hills, MI (US); Rogerio Guedes Alves, Macomb Township, MI (US)

(73) Assignee: CSR TECHNOLOGY INC., Sunnyvale, CA (US)

(21) Appl. No.: 14/012,886

(22) Filed: Aug. 28, 2013

(51) Int. Cl. H04R 3/00

(52) U.S. Cl. CPC H04R 3/005
USPC 381/92

(57) ABSTRACT

A method, apparatus, and manufacture of beamforming is provided. Adaptive null beamforming is performed for signals from first and second microphones of a two-microphone array. The signals from the microphones are decomposed into subbands. Beamforming weights are evaluated and adaptively updated over time based, at least in part, on the direction of arrival and distance of the target signal. The beamforming weights are applied to the subbands at each updated time interval. Each subband is then combined.

### TECHNICAL FIELD

The invention is related to voice enhancement systems, and in particular, but not exclusively, to a method, apparatus, and manufacture of adaptive null beamforming for a two-microphone array in which the beamforming weights are adaptively adjusted over time based, at least in part, on the direction of arrival and distance of the target signal.

### BACKGROUND

Beamforming is a signal processing technique for directional reception or transmission. In reception beamforming, sound may be received preferentially in some directions over others. Beamforming may be used in an array of microphones, for example to ignore noise in one particular direction while listening to speech from another direction.

### BRIEF DESCRIPTION OF THE DRAWINGS

Non-limiting and non-exhaustive embodiments of the present invention are described with reference to the following drawings, in which:

FIG. 1 illustrates a block diagram of an embodiment of a system;

FIG. 2 shows a block diagram of an embodiment of the two-microphone array of FIG. 1;

FIG. 3 illustrates a flowchart of a process that may be employed by an embodiment of the system of FIG. 1;

FIG. 4A shows a diagram of a headset that includes an embodiment of the two-microphone array of FIGS. 1 and/or 2;

FIG. 4B shows a diagram of a handset that includes an embodiment of the two-microphone array of FIGS. 1 and/or 2;

FIGS. 5A and 5B illustrate null beampatterns for an embodiment of the system of FIG. 1;

FIGS. 6A and 6B illustrate null beampatterns for another embodiment of the system of FIG. 1;

FIGS. 7A and 7B illustrate null beampatterns for another embodiment of the system of FIG. 1;

FIGS. 8A and 8B illustrate null beampatterns for another embodiment of the system of FIG. 1;

FIGS. 9A and 9B illustrate null beampatterns for another embodiment of the system of FIG. 1;

FIGS. 10A and 10B illustrate null beampatterns for another embodiment of the system of FIG. 1;

FIG. 11 shows an embodiment of the system of FIG. 1;

FIG. 12 illustrates a flowchart of an embodiment of a process for updating the beamforming weights for an embodiment of the process of FIG. 3;

FIG. 13 shows a functional block diagram of an embodiment of a beamformer of FIG. 11; and

FIG. 14 shows a functional block diagram of an embodiment of a beamformer of FIG. 11, arranged in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “signal” means at least one current, voltage, charge, temperature, data, or other signal.

Briefly stated, the invention is related to a method, apparatus, and manufacture for beamforming. Adaptive null beamforming is performed for signals from first and second microphones of a two-microphone array. The signals from the microphones are decomposed into subbands. Beamforming weights are evaluated and adaptively updated over time based, at least in part, on the direction of arrival and distance of the target signal. The beamforming weights are applied to the subbands at each updated time interval. Each subband is then combined.

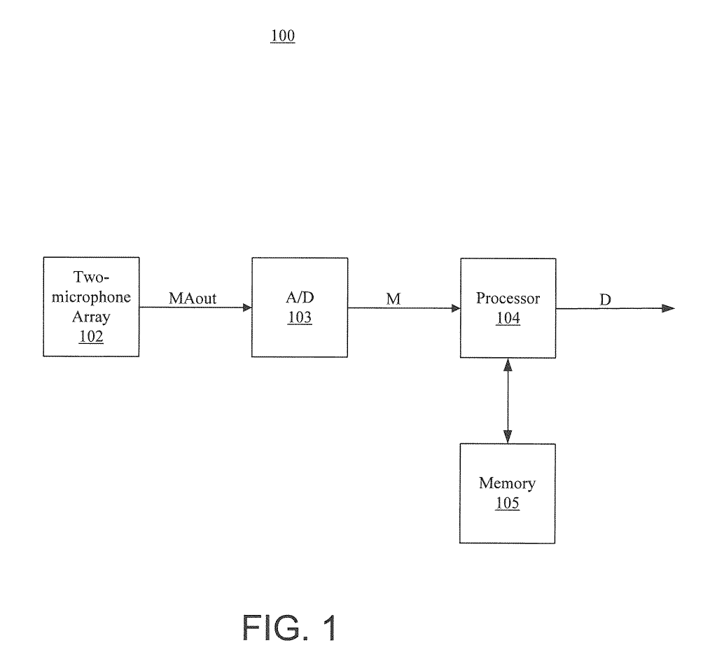

FIG. 1 shows a block diagram of an embodiment of system 100. System 100 includes two-microphone array 102, AD converter(s) 103, processor 104, and memory 105.

In operation, two-microphone array 102 receives sound via two microphones in two-microphone array 102, and provides microphone signal(s) MAout in response to the received sound. AD converter(s) 103 converts microphone signal(s) digital microphone signals M.

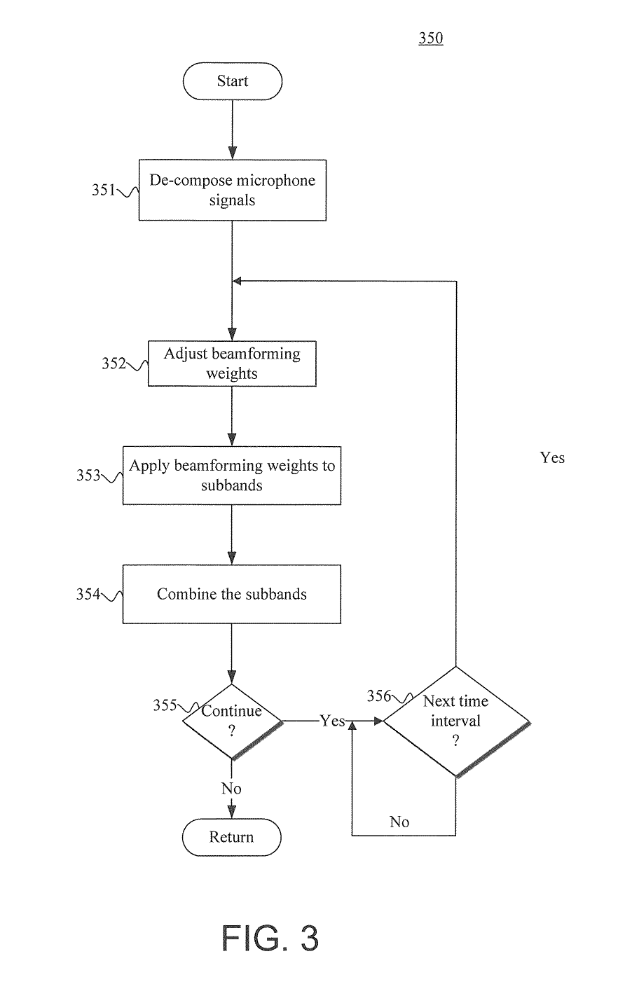

Processor 104 receives microphone signals M, and, in conjunction with memory 105, performs adaptive null beamforming on microphone signals M to provide output signal D. Memory 105 may be a processor-readable medium which stores processor-executable code encoded on the processor-readable medium, where the processor-executable code, when executed by processor 104, enable actions to performed in accordance with the processor-executable code. The processor-executable code may enable actions to perform methods such as those discussed in greater detail below, such as, for example, the process discussed with regard to FIG. 3 below.

Although FIG. 1 illustrates a particular embodiment of system 100, other embodiments may be employed with the scope and spirit of the invention. For example, many more components than shown in FIG. 1 may also be included in system 100 in various embodiments. For example, system 100 may further include a digital-to-analog converter to converter the output signal D to an analog signal. Also, although FIG. 1 depicts an embodiment in which the signal processing algorithms are performed in software, in other embodiments, the signal processing may instead be performed by hardware, or some combination of hardware and/or software. These embodiments and others are within the scope and spirit of the invention.

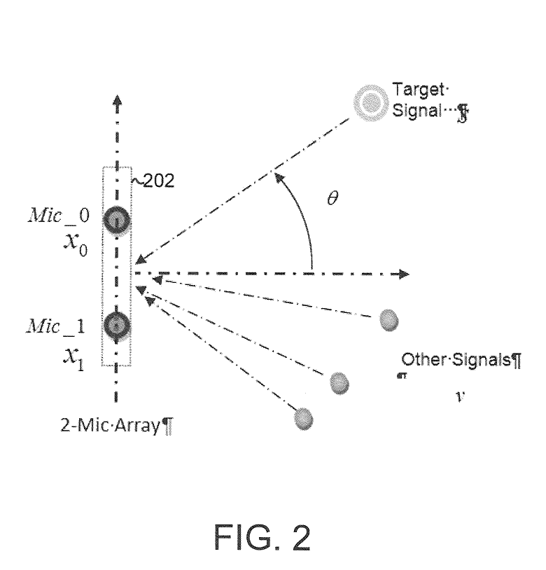

FIG. 2 shows a block diagram of multiple embodiments of microphone array 202, which may be employed as embodiments of two-microphone array 102 of FIG. 1. Two-microphone array 202 includes two microphones, Mic_{—}0 and Mic_{—}1.

Embodiments of processor 104 and memory 105 of FIG. 1 may perform various functions, including null beamforming. Null beamforming or null steering is a technique that may be employed to reject a target signal coming from a certain direction in a space. This technique can be used as a self-stand system to remove the jammer signal while preserving the desired signal, and it also can be employed as a sub-system, for example the signal-blocking module in a GSC system to remove the desired speech and output noise only.

Target signal limpinges on two-microphone array 202. In some embodiments, the target signal is defined as the signal to be removed or suppressed by null beamforming; it can be either the desired speech or environmental noises, depending on the application. After taking the Short-Time Fourier Transform (STFT) of the time domain signal, the signal model of microphone Mic_{—}0 and microphone Mic_{—}1 in each time-frame t and frequency-bin (or subband) k are decomposed as,

Mic_{—}0:x₀(t,k)=s(t,k)+v₀(t,k)

Mic_{—}1:x₁(t,k)=a(t,k)s(t,k)+v₁(t,k) (1)

where xᵢ is the array observation signal in microphone i(iε{0,1}), s is the target signal, vᵢ represents a mix of the rest of the signals in microphone i, and t and k are the time-frame index and frequency-bin (subband) index, respectively. The array steering factor a is a transfer function of target signal from Mic_{—}0 to Mic_{—}1.

Eq. (1) can also be formulated in a vector form, as

x(t,k)=a(t,k)s(t,k)+v(t,k), (2)

where x(t, k)=[x₀(t, k); x₁(t, k)], a(t, k)=[1; a(t, k)], and v(t, k)=[v₀(t, k); v₁(t, k)].

In some embodiments, the beamformer is a linear processor (filter) consisting of a set of complex weights. The output of the beamformer is a linear combination of input signals, given by

z(t,k)=w^{H}(t,k)x(t,k), (3)

where w(t, k)=[w₀(t, k); w₁(t, k)] is the combination weights of the beamformer.

The beamforming weights are w are evaluated and adaptively updated over time based, at least in part, on array steering factor a, which in turn is based, at least in part, on the direction of arrival and distance of target signal s.

FIG. 3 illustrates a flowchart of an embodiment of a process (350) that may be employed by an embodiment of system 100 of FIG. 1. After a start block, the process proceeds to block 351, where first and second microphone signals from the first and second microphones of a two-microphone array are de-composed into subbands. The process then moves to block 352, where beamforming weights are adjusted. At step 352, the beamforming weights are evaluated if not previously evaluated, or if previously evaluated, the beamforming weights are adaptively updated based, at least in part, on the direction of arrival and distance of the target signal. For example, in some embodiments, the beamforming updates are updated based, at least in part, on the direction of arrival and a degradation factor, where the degradation factor in turn is based, at least in part, on the distance of the target signal. The direction of arrival and the degradation factor are evaluated based on input data from the microphone input signals. The direction of arrival and degradation factor are updated iteratively based on step size parameters in some embodiments, where the step size parameters themselves may be iteratively adjusted in some embodiments.

The process then advances to block 353, where the beamforming weights evaluated or updated at block 352 are applied to the subbands. The process then proceeds to block 354, where each of the subbands is combined. The process then moves to decision block 355, where a determination is made as to whether the beamforming should continue. If not, the process advances to a return block, where other processing is resumed. Otherwise, at the next time interval, the process proceeds to decision block 356, where a determination is made as to whether the next time interval has occurred. If not, the process remains at decision block 356 until the next time interval occurs. When the next time interval occurs, the process moves to block 352, where the beamforming weights are adaptively updated based, at least in part, on the direction of arrival and distance of the target signal.

Discussed below are various specific examples and embodiments of process of FIG. 3 given by way of example only. In the discussion of the following embodiments of the process of FIG. 3, nothing should be construed as limiting the scope of the invention, because only non-limited examples are discussed by way of example and explanation.

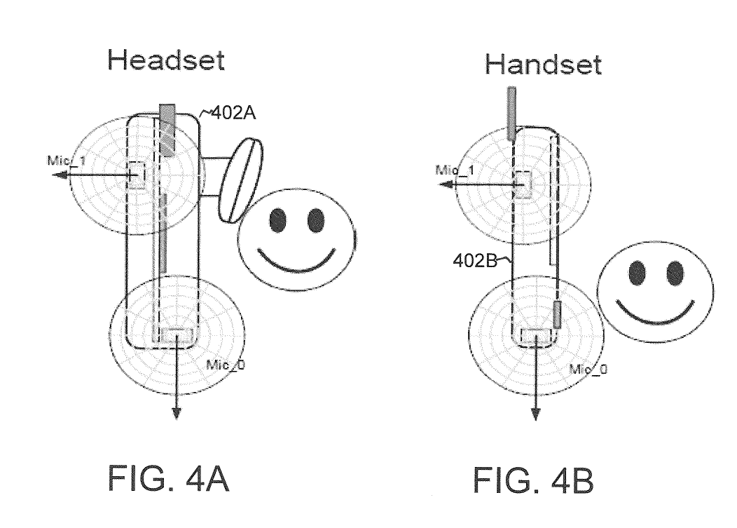

Embodiments of the invention may be employed in various Near-field and far-field Speech Enhancement Systems, such as headset, handsets and hands-free systems. These embodiments and other are within the scope and spirit of the invention. For example, FIGS. 4A and 4B discussed below show embodiments of a headset system and a handset system, respectfully, that could be employed in accordance with embodiments of the invention.

Prior to decomposing the first and second microphone signals into subbands, the first and second microphone signals may be transformed to the frequency domain, for example by taking the STFT of the time domain signals. As discussed above, the frequency domain signals from the first and second microphones are decomposed into subbands, where the subbands are pre-defined frequency bins in which the frequency domain signals are separated into. In some embodiments, the time domain signals may be transformed to the time domain and separated into subbands as part of the same process. For example, in some embodiments, the signals may be decomposed with an analysis filter bank as discussed in greater detail below. The frequency domain signals are complex numbers, and the beamforming weights are also complex numbers.

In various embodiments of step 352 discussed above, the beamforming weights may be adjusted in different ways in different embodiments. In some embodiments, the beamforming weights are defined as functions of, inter alia, β and θ, where θ is the direction of arrival, and β is the speech degradation factor (which is a function of, inter alia, the distance of the target signal from the microphones). In these embodiments, the beamforming weights are defined as functions of β and θ, so that the current values of β and θ may be updated at each time interval. In some embodiments, β and θ may be updated at each time interval based on a step-size parameter, where the step size is adjusted each time interval based on the ratio of the target power to microphone signal power. In various embodiments, different derivations of the adoptive algorithm including different derivations the beamforming weights are defined as functions of β and θ may be employed. These embodiments and others are within the scope and spirit of the invention.

In step 353 above, the beamforming weights may be applied to each subband in accordance with equation (3) above. At step 354, in some embodiments, the subbands may be recombined with a synthesis filter bank, as discussed in greater detail below.

In various embodiments of the process of FIG. 3, the target signal may be, for example, the speech, or the noise. When the speech is targeted, the speech is nulled, so that only the noise remains in the output signal. In some embodiments in which the speech is nulled, the output may be used as a noise environment or noise reference that is provided to other modules (not shown), which may in turn be used to provide noise cancellation in some embodiments.

FIG. 4A shows a diagram of a headset that includes an embodiment of two-microphone array 402A, which may be employed as an embodiment of two-microphone array 102 of FIG. 1 and/or two-microphone array 202 of FIG. 2. FIG. 4A shows an embodiment of two-microphone array 102 and/or 202 that may be employed in a headset application.

FIG. 4B shows a diagram of a handset that includes an embodiment of two-microphone array 402B, which may be employed as an embodiment of two-microphone array 102 of FIG. 1 and/or two-microphone array 202 of FIG. 2. FIG. 4B shows an embodiment of two-microphone array 102 and/or 202, which may be employed in a handset application.

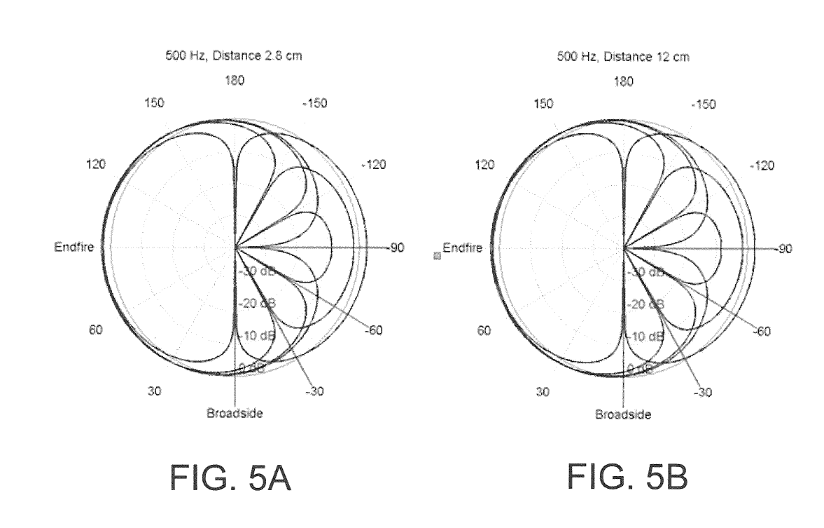

FIGS. 5A-10B illustrate various null beampatterns for an embodiment of system 100 of FIG. 1. The task of null beamforming is to reject a certain interested signal, for example, the target signal s.

The process of a simple null beamformer can be formulated as:

$$z ( t , k ) = \frac{1}{r ( t , k ) - a ( t , k )} ( {x}_{1} ( t , k ) - a ( t , k ) {x}_{0} ( t , k ) ) , \qquad ( 4 )$$

where the r (t, k) is defined as a power “normalization” factor which normalizes power of output z by a certain strategy. From Eq. (1), the output signals z(t, k) should not contain the target signal s, because of the operation of subtraction, e.g.: x₁(t, k)−a(t, k)x₀(t, k) as in Eq. (4), and accordingly only has component of the other signals vᵢ(t, k).

From Eq. (4), the weights of the same null beamformer can be formulated as,

$${w}_{0} ( t , k ) = \frac{- {a}^{*} ( t , k )}{{r}^{*} ( t , k ) - {a}^{*} ( t , k )} \\ {w}_{1} ( t , k ) = \frac{1}{{r}^{*} ( t , k ) - {a}^{*} ( t , k )} \qquad ( 5 )$$

where ( )* denotes the operation of conjugate, or in the vector form, as

$$w ( t , k ) = [ \begin{matrix}\frac{- {a}^{*} ( t , k )}{{r}^{*} ( t , k ) - {a}^{*} ( t , k )} \\ \frac{1}{{r}^{*} ( t , k ) - {a}^{*} ( t , k )}\end{matrix} ] . \qquad ( 6 )$$

It follows that z=(t, k)=w^{H}(t, k)x(t, k)=w^{H}(t, k)v(t, k), where the target signal s is removed from the output of the null beamformer.

As previously discussed, in some embodiments, the beamforming weights w are adaptively updated over time based on the array steering factor a, where the array steering factor a is based on the direction of arrival and the degradation factor. Because the direction of arrival and the degradation factor are not fixed, the beamforming weights are adaptively self-optimized in some embodiments. During design of the beamformer, a framework may be employed in order to achieve adaptive self-optimization during subsequent operation. In some embodiments, the framework used to solve the optimization problem consists basically of 3 steps:

1—Define an objective function which describes the objective problem. In one embodiment, the objective function corresponds to the normalized power of z(t, k).

2—After defining the objective function, the strategy used to obtain the solution is described. Generally, it is the minimization of the objective function described on step one.

3—Finally, the minimization algorithm to solve the problem defined on step 2 is defined. In some embodiments, the steepest descent method may be employed.

The derivation of an embodiment of a particular adaptive optimization algorithm is discussed in detail below.

From Eq. (4), formulation of null beamforming is the determined by the array steering factor a, which, in one embodiment, may be modeled by two factors: degradation factor β and direction-of-arrival (DOA) θ of target signal, i.e.:

$$a ( t , k ) = β ( t , k ) {e}^{\frac{- j 2 π Df ( k ) s i n ( θ ( t ) )}{C}} \qquad ( 7 )$$

where e is the Euler's constant, D is the distance between Mic_{—}0 and Mic_{—}1, and C is the speed of sound. f(k) is the frequency of frequency-bin (or subband) of index k. For example, if the sample rate is 8000 samples per second and the FFT size is 128, it follows that

$$f ( k ) = \frac{8000}{128} ( k - 1 ) ,$$

for k=1, 2, . . . , 128. These variables are assumed to be constant in this example. θ(t)ε[−90°, 90°] is the DOA of target signal impinging on the 2-Mic array at time-frame index t. If θ(t)=−90° or θ(t)=90°, the target signal hits the array from the end-fire. If θ(t)=0°, the target signal hits the array from the broadside. θ can be assumed to have the same value in all the frequency-bins (subbands). The degradation factor β(t, k) is a positive real number that represents the amplitude degradation from the primary Mic_{—}0 to the secondary Mic_{—}1, that is β(t, k)ε[0,1]. When β(t, k)=1, the target signal is called from the far-field; while β(t, k)<1, the signal model is called from the near-field. β(t, k) can be different in the different frequency-bins (subbands), since transmitting from one microphone to another, acoustic sound may degrade differently in different frequencies.

The degradation factor and DOA factor mainly control the array steering factor of the target signal impinging on the array. The degradation factor β and DOA θ may vary with time-frame t, if the location of target signal moves with respect of the array. Accordingly, in some embodiments, a data-driven method is employed to adaptively adjust the degradation factor β and the DOA θ in each frequency-bin (subband), as described in more detail as follows for some embodiments.

In some embodiments, the chosen objective function is the normalized power of the beamformer output, which can be derived by first computing the following three second-order statistics,

Pₓ_{₀}(k)=E{x₀(t,k)x*₀(t,k)} (8)

Pₓ_{₁}(k)=E{x₁(t,k)x*₁(t,k)} (9)

Cₓ_{₀}ₓ_{₁}(k)=E{x₀(t,k)x*₁(t,k)} (10)

where E{•} is the operation of expectation, Pₓ_{₀}(k) and Pₓ_{₁}(k) are power of signals in Mic_{—}0 and Mic_{—}1 in each frequency-bin (subband) k, respectively, and Cₓ_{₀}ₓ_{₁}(k) is the cross-correlation of signals in Mic_{—}0 and Mic_{—}1. Their run-time values can be estimated by first-order smoothing method, as

Pₓ_{₀}(t,k)=εPₓ_{₀}(t−1,k)+(1−ε)x₀(t,k)x*₀(t,k) (11)

Pₓ_{₁}(t,k)=εPₓ_{₁}(t−1,k)+(1−ε)x₁(t,k)x*₁(t,k) (12)

Cₓ_{₀}ₓ_{₁}(t,k)=εCₓ_{₀}ₓ_{₁}(t−1,k)+(1−ε)x₀(t,k)x*₁(t,k) (13)

where ε is a smoothing factor that has a value of 0.7 in some embodiments. Further, their corresponding normalized statistics may be defined as,

$$\begin{matrix}{NP}_{{x}_{0}} ( t , k ) = \frac{{P}_{{x}_{0}} ( t , k )}{\sqrt{{P}_{{x}_{0}} ( t , k ) {P}_{{x}_{1}} ( t , k )}} & ( 14 ) \\ {NP}_{{x}_{1}} ( t , k ) = \frac{{P}_{{x}_{1}} ( t , k )}{\sqrt{{P}_{{x}_{0}} ( t , k ) {P}_{{x}_{1}} ( t , k )}} \\ and , & ( 15 ) \\ {NC}_{{x}_{0} {x}_{1}} ( t , k ) = \frac{{C}_{{x}_{0} {x}_{1}} ( t , k )}{\sqrt{{P}_{{x}_{0}} ( t , k ) {P}_{{x}_{1}} ( t , k )}} & ( 16 )\end{matrix}$$

Using Eq. (4), the output power of z may be obtained as:

$${P}_{z} ( t , k ) = ( \frac{1}{r ( t , k ) - a ( t , k )} ) ( \frac{1}{{r}^{*} ( t , k ) - {a}^{*} ( t , k )} ) ( \begin{matrix}{P}_{{x}_{1}} ( t , k ) + a ( t , k ) {a}^{*} ( t , k ) {P}_{{x}_{0}} ( t , k ) - \\ a ( t , k ) {C}_{{x}_{0} {x}_{1}} ( t , k ) - {a}^{*} ( t , k ) {C}_{{x}_{0} {x}_{1}}^{*} ( t , k )\end{matrix} ) \qquad ( 17 )$$

And the normalized power of beamformer output (t, k), e.g.,

$${NP}_{z} ( t , k ) = \frac{{P}_{z} ( t , k )}{\sqrt{{P}_{{x}_{0}} ( t , k ) {P}_{{x}_{1}} ( t , k )}}$$

can be written as:

$${NP}_{z} ( t , k ) = ( \frac{1}{r ( t , k ) - a ( t , k )} ) ( \frac{1}{{r}^{*} ( t , k ) - {a}^{*} ( t , k )} ) ( \begin{matrix}{NP}_{{x}_{1}} ( t , k ) + a ( t , k ) {a}^{*} ( t , k ) {NP}_{{x}_{0}} ( t , k ) - \\ a ( t , k ) {NC}_{{x}_{0} {x}_{1}} ( t , k ) - {a}^{*} ( t , k ) {NC}_{{x}_{0} {x}_{1}}^{*} ( t , k )\end{matrix} ) \qquad ( 18 )$$

In some embodiments, the cost function for the degradation factor β and the DOA θ is defined as the normalized power of z, that is:

J(β,θ)=NP_{z}. (19)

The optimal values of β and θ can be solved through the minimization of this cost function, i.e.:

{β⁰,θ⁰}=arg min J(β,θ). (20)

Adjusting the power normalization factor r is discussed below.

Eq. (20) can be solved using approaches derived by iterative optimization algorithms. For simplicity, a function may be defined

$$φ ( θ , t , k ) = {e}^{\frac{- j 2 π Df ( k ) si n ( θ ( t ) )}{C}} .$$

Without ambiguity, the time-frame index t and frequency-bin index k are omitted in the following derivations.

The cost function in Eq. (18) can be simplified as:

$$J = \frac{1}{{rr}^{*} - {r}^{*} β φ - r β {φ}^{*} + {β}^{2}} ( {NP}_{{x}_{1}} + {β}^{2} {NP}_{{x}_{0}} - β φ {NC}_{{x}_{0} {x}_{1}} - β {φ}^{*} {NC}_{{x}_{0} {x}_{1}}^{*} ) \qquad ( 21 )$$

Further, the cost function J may be divided in two parts, as

$$\begin{matrix}J = {J}_{1} * {J}_{2} \\ where , & ( 22 ) \\ {J}_{1} = \frac{1}{{rr}^{*} - {r}^{*} β φ - r β {φ}^{*} + {β}^{2}} & ( 23 )\end{matrix}$$

is independent of the input data and,

J₂=NPₓ_{₁}+β²NPₓ_{₀}−βφNCₓ_{₀}ₓ_{₁}−βφ*NC*ₓ_{₀}ₓ_{₁} (24)

is data-dependent.

An iterative optimization algorithm for real-time processing can be derived using the steepest descent method as:

$$\begin{matrix}\begin{matrix}β ( t + 1 ) = β ( t ) - {μ}_{β} \frac{\partial J ( t )}{\partial β} \\ = β ( t ) - {μ}_{β} ( \frac{\partial {J}_{1} ( t )}{\partial β} {J}_{2} ( t ) + \frac{\partial {J}_{2} ( t )}{\partial β} {J}_{1} ( t ) )\end{matrix} \\ and , & ( 25 ) \\ \begin{matrix}θ ( t + 1 ) = θ ( t ) - {μ}_{θ} \frac{\partial J ( t )}{\partial θ} \\ = θ ( t ) - {μ}_{θ} ( \frac{\partial {J}_{1} ( t )}{\partial θ} {J}_{2} ( t ) + \frac{\partial {J}_{2} ( t )}{\partial θ} {J}_{1} ( t ) )\end{matrix} & ( 26 )\end{matrix}$$

where μ_{β} and μ_{θ} are the step-size parameters for updating β and θ, respectively. The gradients for updating degradation factor β are derived below:

$$\begin{matrix}\frac{\partial {J}_{1}}{\partial β} = {( \frac{1}{{rr}^{*} - {r}^{*} βφ - r {βφ}^{*} + {β}^{2}} )}^{2} \cdot ( {r}^{*} φ + r {φ}^{*} - 2 β ) \\ and , & ( 27 ) \\ \frac{\partial {J}_{2}}{\partial β} = 2 β {NP}_{{x}_{0}} - φ {NC}_{{x}_{0} {x}_{1}} - {φ}^{*} {NC}_{{x}_{0} {x}_{1}}^{*} & ( 28 )\end{matrix}$$

Denoting

$$γ = \frac{- j2π Df ( k )}{c} , φ = {e}^{γ sin ( θ )} ,$$

the gradients for updating DOA factor θ can be obtained as:

$$\begin{matrix}\frac{\partial {J}_{1}}{\partial β} = {( \frac{1}{{rr}^{*} - {r}^{*} βφ - r {βφ}^{*} + {β}^{2}} )}^{2} β \cdot γ \cdot cos ( θ ) \cdot ( {r}^{*} φ + r {φ}^{*} ) \\ and , & ( 27 ) \\ \frac{\partial {J}_{2}}{\partial β} = β \cdot γ \cdot cos ( θ ) \cdot ( {φ}^{*} {NC}_{{x}_{0} {x}_{1}}^{*} - φ {NC}_{{x}_{0} {x}_{1}} ) . & ( 28 )\end{matrix}$$

Once the two factors are updated by Eq. (25) and Eq. (26), the array steering factor for target signal can be reconstructed from Eq. (7) as:

$$a ( t + 1 , k ) = β ( t + 1 , k ) {e}^{\frac{- j2π Df ( k ) sin ( θ ( t + 1 ) )}{C}} , \qquad ( 31 )$$

Generating the beamforming output as in Eq. (4) may also include updating the power normalization factor, e.g. r(t+1,k), which is discussed below. In certain embodiments, the power normalization factor r either is solely decided by the updated value of a or can be pre-fixed and time-invariant, depending on specific application.

The output of the null beamformer may be generated using Eq. (4) as,

$$z ( t + 1 , k ) = \frac{1}{r ( t + 1 , k ) - a ( t + 1 , k )} ( {x}_{1} ( t + 1 , k ) - a ( t + 1 , k ) {x}_{0} ( t + 1 , k ) ) . \qquad ( 32 )$$

In the vector form, the null beamformer weights may be updated as,

$$w ( t + 1 , k ) = [ \begin{matrix}\frac{- {a}^{*} ( t + 1 , k )}{{r}^{*} ( t + 1 , k ) - {a}^{*} ( t + 1 , k )} \\ \frac{1}{{r}^{*} ( t + 1 , k ) - {a}^{*} ( t + 1 , k )}\end{matrix} ] \qquad ( 33 )$$

and the output of the null beamformer may be given as:

z(t+1,k)=w^{H}(t+1,k)x(t+1,k). (34)

In some embodiments, the null beamformer may be implemented as the signal-blocking module in a generalized sidelobe canceller (GSC), where the task of the null beamformer is to suppress the desired speech and only output noise as a reference for other modules. In this application context, the other signals vᵢ in signal model Eq. (1) are the environmental noise picked up by the 2-Mic array, and the target signal to be suppressed in Eq. (1) is the desired speech.

For this type of application, in some embodiments, it may be desirable for the null beamformer to keep the power of output equal to that of input noise. This power constraint may be formulated as:

E{|w^{H}(t,k)v(t,k)|²}=E{|v₀(t,k)|²} (35)

or,

E{|w^{H}(t,k)v(t,k)|²}=E{|v₁(t,k)|²}. (36)

It some embodiments, it is assumed that the noises in the two microphones have the same power and known normalized correlation, γ(k) that is invariant with time, e.g.:

$$\begin{matrix}E \{ {\vert {v}_{0} ( t , k ) \vert}^{2} \} = E \{ {\vert {v}_{1} ( t , k ) \vert}^{2} \} \\ and , & ( 37 ) \\ \frac{E \{ {v}_{0} ( t , k ) {v}_{1}^{*} ( t , k ) \}}{\sqrt{E \{ {\vert {v}_{0} ( t , k ) \vert}^{2} \} E \{ {\vert {v}_{1} ( t , k ) \vert}^{2} \}}} = γ ( k ) . & ( 38 )\end{matrix}$$

The power constraints of Eq. (35) or Eq. (36) can be written as,

$${w}^{H} ( t , k ) [ \begin{matrix}1 & γ ( k ) \\ {γ}^{*} ( k ) & 1\end{matrix} ] w ( t , k ) = 1 , \qquad ( 39 )$$

that is,

r(t,k)r*(t,k)−r(t,k)a*(t,k)−r*(t,k)a(t,k)=1−γ*(k)a*(t,k)−γ(k)a(t,k), (40)

Omitting the index number of t and k for notation simplicity, and denoting r=Re^{jφ}_{ᵣ}, a=Ae^{jφ}_{ₐ}, and γ=Γe^{jφ}_{_{γ}}, Eq. (40) can be re-written in polar coordinates as:

R²−2·R·A·Re{e^{jφ}_{ᵣ}^{-jφ}_{ₐ}}+2·Γ·A·Re{e^{jφ}_{_{γ}}^{+jφ}_{ₐ}}−1=0 (41)

where Re{•} represents the real part of a variable. Since a(t, k) is known from Eq. (31), and γ(k) is known by assumption, therefore, Eq. (41) has only two unknown variables: R and φᵣ. The solutions of R and φᵣ may be infinite. However, φᵣ can be pre-specified as a constant and solve Eq. (41) solved for R. Possible solutions for two example applications in accordance with certain embodiments are discussed below.

In an example of diffuse noise field, the normalized correlation of noise is a frequency-dependent real number, e.g.:

φ_{γ}=0

γ(k)==Γ(k) (42)

By setting φᵣ=φₐ, R can be solved from,

R²−2RA+2·ΓA·cos(φₐ)−1=0 (43)

Or, by setting φᵣ=0, R can be solved from,

R²−2·R·A·cos(φₐ)+2·Γ·A·cos(φₐ)−1=0 (44)

Since φₐ and A are known, R can be solved from quadratic Eq. (43) or Eq. (44) at least from least-mean-square error sense. In this case, the solution of r(t, k) is depending on a(t, k) which is updated in each time-frame t, and accordingly may also be updated in each time-frame t.

In another example, the noise is assumed to be coming from the broadside to the 2-Mic array, and then the normalized correlation of noise γ(k)=1, e.g.,

φ_{γ}=0

γ(k)=1 (45)

By setting φᵣ=0, R can be solved from,

R²−2·R·A·cos(φₐ)+2·A·cos(φₐ)−1=0. (46)

One possible solution of Eq. (46) is R=1, and the power normalization factor may be obtained as,

r(t,k)=1 (47)

which is time-invariant and frequency-independent.

Some embodiments of the invention may also be employed to enhance the desired speech and reject the noise signal by forming a spatial null in the direction of strongest noise power. In this application context, the other signals vᵢ in signal model Eq. (1) may be considered the desired speech, and the target signal to be suppressed in Eq. (1) may be the environmental noise picked up by the 2-Mic array.

Typical applications include headset and handset, where desired speech direction is fixed while noise direction is randomly changing. By modeling the “other signals” as the desired speech, the signal model in Eq. (1) can be rewritten as,

Mic_{—}0:x₀(t,k)=s(t,k)+v(t,k)

Mic_{—}1:x₁(t,k)=a(t,k)s(t,k)+σ(k)v(t,k) (48)

where v represents the desired speech that needs to be enhanced, σ is the array steering factor for the desired speech v, assumed to be invariant with time and known, s is the environmental noise that need to be removed, and σ is its array steering factor.

In some embodiments, the power normalization factor of the null beamformer keeps the desired speech undistorted at the output of the null beamformer while minimizing the power of output noise. The distortionless requirement can be fulfilled by the imposing constrain on the weights of the null beamformer, as)

w^{H}(t,k)σ(k)=1 (49)

where σ(k)=[1:σ(k)], the vector form of array steering vector of the desired speech v.

Using Eq. (6) and Eq. (49), it follows that:

$$\frac{1}{r ( t , k ) - a ( t , k )} ( θ ( k ) - a ( t , k ) ) = 1 \qquad ( 50 )$$

Solving the above equation, the power normalization factor r(t k) is given by,

r(t,k)=σ(k), (51)

which is a time-invariant constant and guarantees that the desired speech at the output of the null beamformer is undistorted.

In general, the theoretical value for the degradation factor β is within the range of [0, 1], and the DOA θ has the range of [−90°, 90°]. In practice, these two factors may have smaller ranges of possible values in particular applications. Accordingly, in some embodiments, the solutions for these two factors can be viably limited to a pre-specified range or even to a fixed value.

For example, in some embodiments of headset applications, if the distance between two microphones is 4 cm, the value of β will be around 0.7 and the DOA of the desired speech will be close to 90°. If the null beamformer is used to suppress the desired speech, β and θ can be limited within ranges of [0.5, 0.9] and [70°, 90°], respectively, during the adaptation. If the null beamformer is used to enhance the desired speech while suppress the environmental noise, the null beamformer can fix β=1 under far-field noise assumption and adapt θ within the range of [−90°, 70°].

Since the array steering factor a depends only on the target signal, further control based on the target to signal power ratio (TR) may be employed. The mechanism can be described as, if the target signal is inactive, the microphone array merely capturing other signals and thus the adaptation should be on hold. On the other hand, if the target signal is active, the information of steering factor a is available and the adaptation should be activated; the adaptation step-size can be set corresponding to the ratio of target power to microphone signal power; in other words: the higher the TR, the larger the step-size.

The target to signal power ratio (TR) can be defined as,

$$TR = \frac{{P}_{z}}{\sqrt{{P}_{{x}_{0}} {P}_{{x}_{1}}}} \qquad ( 52 )$$

where Pₛ is the estimated the target power, and Pₓ_{₀} and Pₓ_{₁} are the power of microphone input signals, as computed in Eq. (11) and Eq. (12). In practice, Pₛ is typically not directly available but can be approximated by \sqrt{Pₓ_{₀}Pₓ_{₁}}−P_{z}. Therefore, an estimated TR can be obtain by,

$$TR = 1 - min \{ \frac{{P}_{z}}{\sqrt{{P}_{{x}_{0}} {P}_{{x}_{1}}}} , 1 \} , \qquad ( 53 )$$

In some embodiments, the adaptive step-size μ is adjusted proportional to TR. Hence, the refined step-size may be obtained as,

$${μ}_{2} = μ ( 1 - min \{ \frac{{P}_{z}}{\sqrt{{P}_{{x}_{0}} {P}_{{x}_{1}}}} \} ) . \qquad ( 54 )$$

The derivation of an embodiment of a particular adaptive optimization algorithm has been discussed above. Besides Eq. (4), another simple null beamforming equation can be formulated as:

$$\hat{z} ( t , k ) = \frac{1}{r ( t , k ) - \frac{1}{a ( t , k )}} ( {x}_{0} ( t , k ) - \frac{1}{a ( t , k )} {x}_{1} ( t , k ) ) . \qquad ( 55 )$$

Similar derivations of adaptive algorithm for this type of null beamforming can also be obtained from the method discussed above. These embodiments and others are within the scope and spirit of the invention.

FIGS. 5A and 5B show embodiments of beampatterns at 500 Hz for adaptively suppressing desired speech from −30 degree, −60 degree and −90 degree, while adaptively normalizing output noise power for a diffuse noise field.

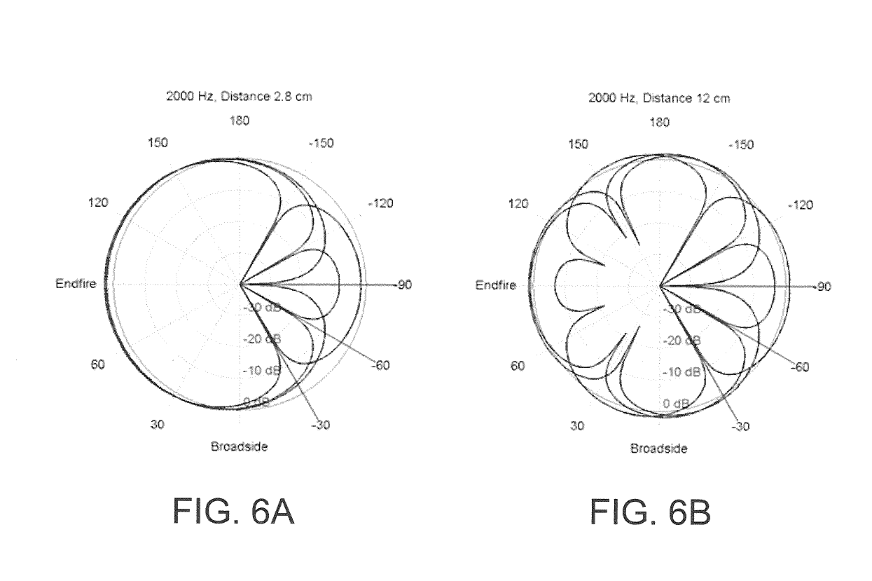

FIGS. 6A and 6B show embodiments of beampatterns at 2000 Hz for adaptively suppressing desired Speech from −30 degree, −60 degree and −90 degree, while adaptively normalizing output noise power for a diffuse noise field.

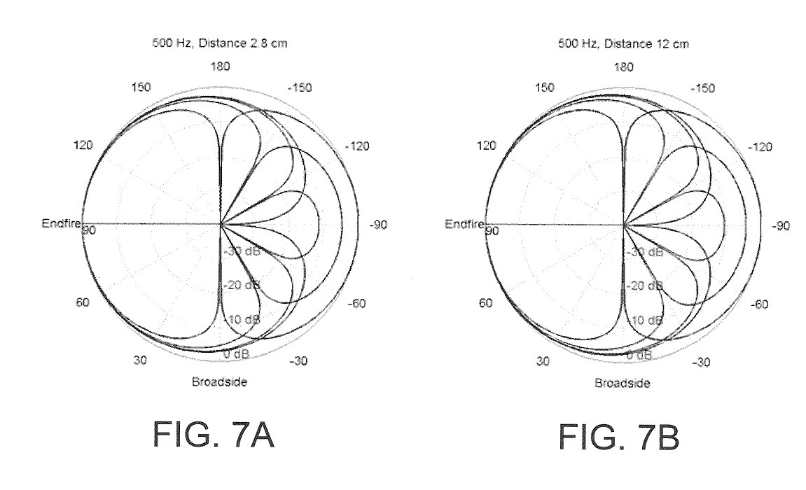

FIGS. 7A and 7B show embodiments of beampatterns at 500 Hz for adaptively enhancing desired speech from end-fire, while adaptively adaptive suppressing noise from 0 degree, −30 degree, −60 degree and −90 degree.

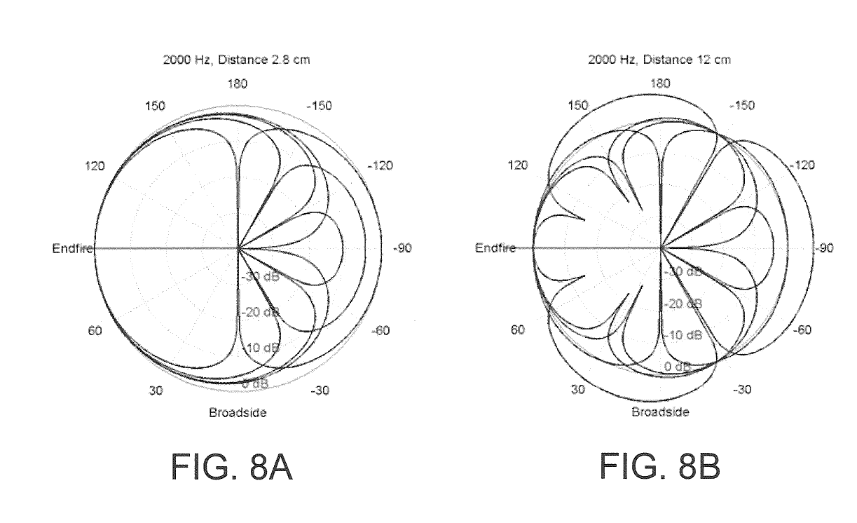

FIGS. 8A and 8B show embodiments of beampatterns at 2000 Hz for adaptively enhancing desired speech from end-fire, while adaptively adaptive suppressing noise from 0 degree, −30 degree, −60 degree and −90 degree.

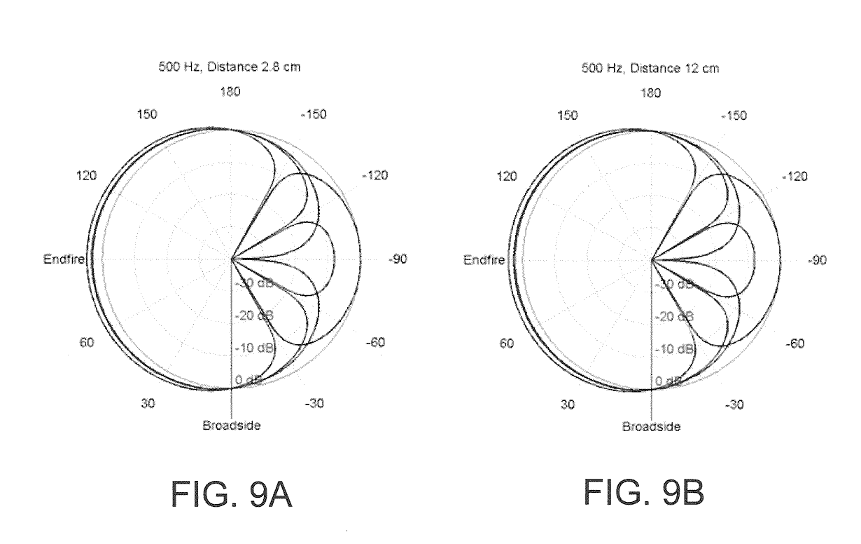

FIGS. 9A and 9B show embodiments of beampatterns at 500 Hz for enhancing desired speech from broadside while adaptively suppressing noise from −30 degree, −60 degree and −90 degree.

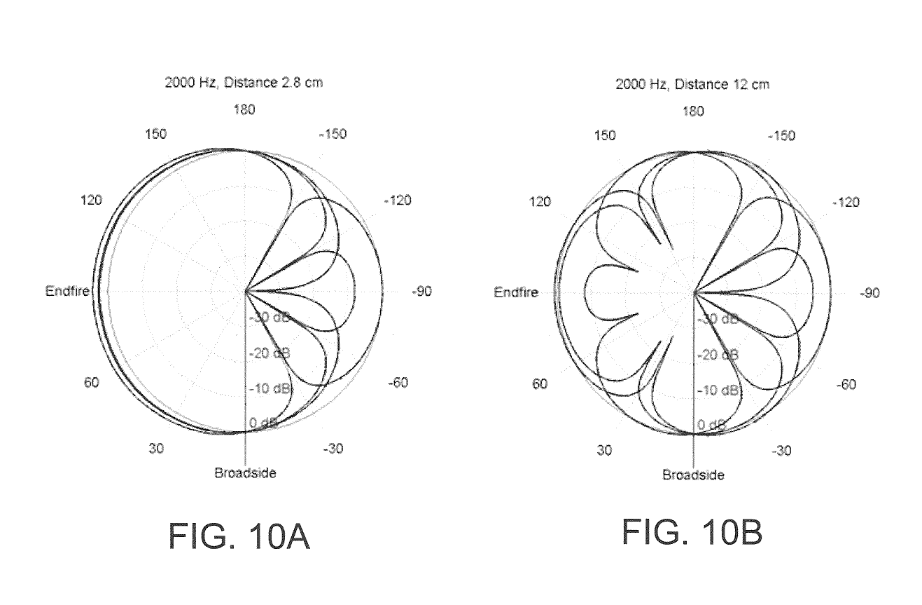

FIGS. 10A and 10B show embodiments of beampatterns at 2000 Hz for enhancing desired speech from broadside while adaptively suppressing noise from −30 degree, −60 degree and −90 degree.

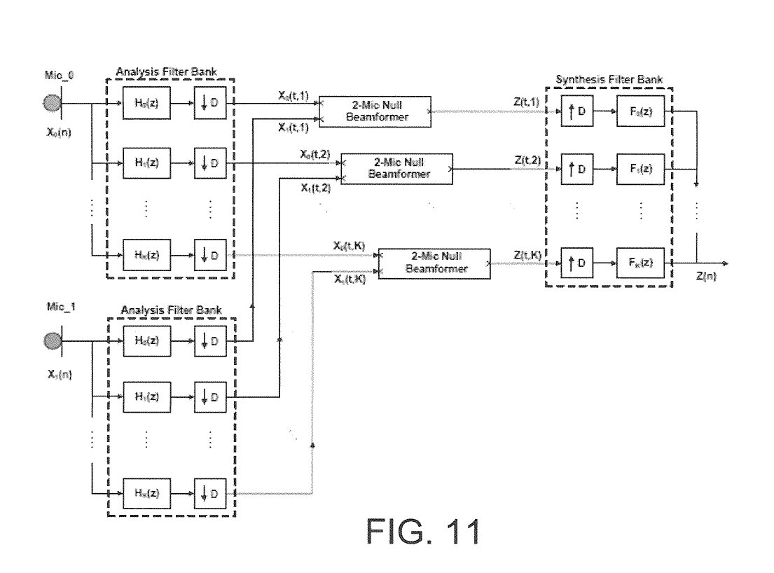

FIG. 11 shows an embodiment of the system 1100, which may be employed as an embodiment of system 100 of FIG. 1. System 1100 includes two-microphone array 1101, analysis filter banks 1161 and 1162, two-microphone null beamformers 1171, 1172, and 1173, and synthesis filter bank 1180. Two-microphone array 1102 includes microphone Mic_{—}0 and Mic_{—}1. In some embodiments, analysis filter banks 1161 and 1162, two-microphone null beamformers 1171, 1172, and 1173, and synthesis filter bank 1180 are implemented as software, and may be implemented for example by a processor such as processor 104 of FIG. 1 processing processor-executable code retrieved from memory such as memory 105 of FIG. 1.

In operation, microphones Mic_{—}0 and Mic_{—}1 provide signals x₀(n) and x₁(n) to analysis filter banks 1161 and 1162 respectively. System 1100 works in the frequency (or subband) domain; accordingly, analysis filter banks 1161 and 1162 are used to decompose the discrete time-domain microphone signals into subbands, then for each subband the 2-Mic null beamforming is employed by two-microphone null beamformers 1171-1173, and after that a synthesis filter bank (1180) is used to generate the time-domain output signal, as illustrated in FIG. 11.

As discussed in greater detail above and below, two-microphone null beamformers 1171-1173 apply weights to the subbands, while adaptively updating the beamforming weights at each time interval. The weights are updated based on an algorithm that is pre-determined by the designer when designing the beamformer. An embodiment of a process for pre-determining an embodiment of an optimization algorithm during the design phase is discussed in greater detail above. During device operation, the optimization algorithm determined during design is employed to update the beamforming weights at each time interval during operation.

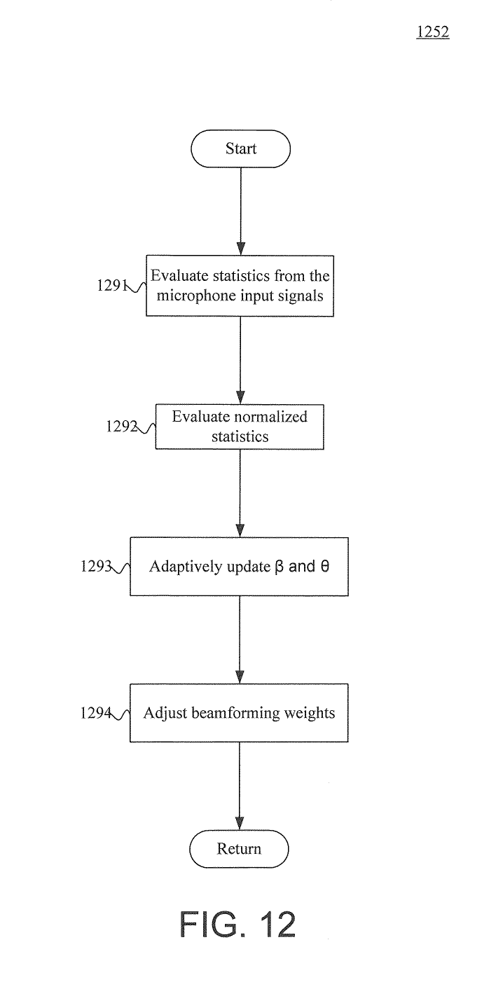

FIG. 12 illustrates a flowchart of an embodiment of process 1252. Process 1252 may be employed as a particular embodiment of block 352 of FIG. 3. In some embodiments, process 1252 may be employed for updating the beamforming weights for an embodiment of system 100 of FIG. 1 and/or system 1100 of FIG. 11.

After a start block, the process proceeds to block 1291, where statistics from the microphone input signals are evaluated. Different statistics may be evaluated in different embodiments based on the particular adaptive algorithm that is being employed. For example, as discussed above, in some embodiments, the adaptive algorithm is employed to minimize the normalized power. In some embodiments, at block 1291, the values of Pₓ₀, Pₓ₁, and Cₓ₀ₓ₁ are the values that are evaluated, which may be evaluated based in accordance with equations (11), (12), and (12) respectively as given above in some embodiments. As given in equations (11), (12), and (12), Pₓ₀ is a function of first microphone input signal x₀, Pₓ₁ is a function of second microphone input signal x₁, and Cₓ₀ₓ₁ is a function of both microphone signals x₀ and x₁.

The process then moves to block 1292, where corresponding normalized statistics of the statistics evaluated in block 1291 are determined. In embodiments in which the adaptive algorithm does not use normalized values, this step may be skipped. In embodiments in which Pₓ₀, Pₓ₁, and Cₓ₀ₓ₁ are the values that were evaluated at step 1291, in step 1292, the normalized statistics NPₓ₀, NPₓ₁, and NCₓ₀ₓ₁ may be evaluated, for example in accordance with equations (14)-(16) in some embodiments.

The process then advances to block 1293, where values of β and θ are adaptively updated. In some embodiments, β and θ are updated based on a derivation of an objective function employing step-size parameters where the step-size parameters are updated based on the ratio of the power of the target signal to the microphone signal power. In some embodiments, the updated values of β and θ are determined in accordance with equations (25) and (26), respectively.

In some embodiments, the updated values of β and θ are used to evaluate an updated value for array steering factor a, for example in accordance with equation (31) in some embodiments.

The process then proceeds to block 1294, where the beamforming weights are adjusted, for example based on the adaptively adjusted value of the array steering array a. In some embodiments, after adaptively adjusting a, but before adjusting the beamforming weights at step 1294, the power normalization factor r is adaptively adjusted. For example, in some embodiments, the power normalization factor r is adaptively adjusted based on the updated value of array steering factor a. In other embodiments, power normalized factor is employed as a time-invariant constant.

In some embodiments, the beamforming weights are adjusted at block 1294 based on, for example, equation (33). In other embodiments, the beamforming weights may be updated based on a different null beamforming derivation, such as, for example, equation (55). A previous embodiment shown above employed minimization of the normalized power using a steepest descent method. Other embodiments may employ other optimization approaches than minimizing the normalized power, and/or employ methods other than the steepest descent method. These embodiments and others are within the scope and spirit of the invention.

The process then moves to a return block, where other processing is resumed.

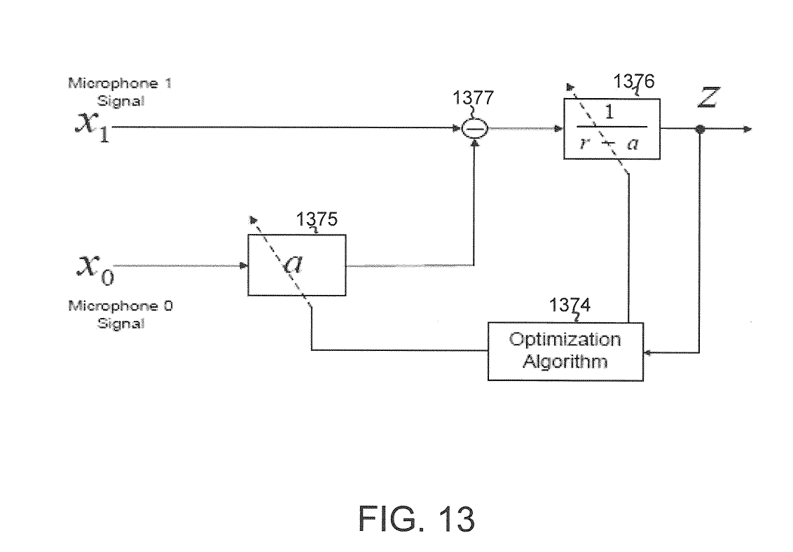

FIG. 13 shows a functional block diagram of an embodiment of beamformer 1371, which may be employed as an embodiment of beamformer 1171, 1172, and/or 1173 of FIG. 11. Beamforming 1371 includes optimization algorithm block 1374 and functional blocks 1375, 1376, and 1388.

In operation, the two inputs x₀ and x₁ from the 2-Mic array (e.g., two-microphone array 102 of FIG. 1 or 1102 of FIG. 11) are processed by null beamformer 1371. The beamforming processing is a spatial filtering and is formulated as

$$z = \frac{1}{r - a} ( {x}_{1} - {ax}_{0} ) ,$$

where z is the output of the null beamformer. Specifically, the adaptation algorithm is represented by the module of “Optimization Algorithm” 1374. The parameter a is applied to signal x₀ by functional block 1375, to multiply a by x₀ to generate ax₀, where the parameter a is updated at each time interval by optimization algorithm 1374. Functional block 1377 provides signal x₁-ax₀ from the input of functional block 1177. The parameter 1(r−a) is applied to signal x₁-ax₀ to generate signal z. This is applied to each subband.

FIG. 13 illustrates a functional block diagram of a particular embodiment of a null beamformer. Other null beamforming equations may be employed in other embodiments. These embodiments and others are within the scope and spirit of the invention.

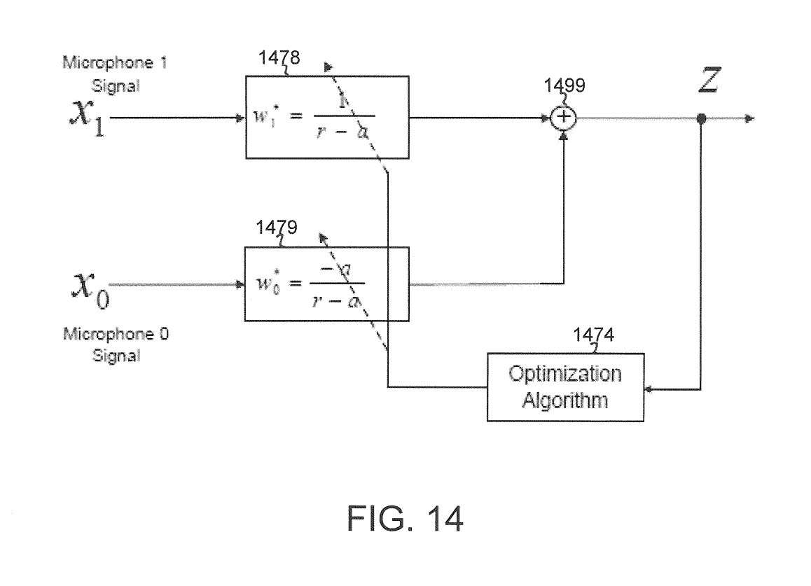

FIG. 14 shows a functional block diagram of an embodiment beamformer 1471, which may be employed as an embodiment of beamformer 1171, 1172, and/or 1173 of FIG. 11. Beamforming 1471 includes optimization algorithm block 1374, beamforming weight blocks 1478 and 1479, and summer block 1499. Beamforming 1471 is equivalent to block 1371, but presents the beamformer based on weights of the beamformer.

Beamforming weight blocks 1478 each represent a separate beamforming weight. During operation, a beamforming weight is applied from the corresponding beamforming weight block to each subband of each microphone signal provided from the two-microphone array. Optimization algorithm 1474 is employed to update each beamformer weight of each beamforming weight block at each time interval. Summer 1499 is employed to add the signals together after the beamforming weights have been applied.

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A method, comprising:
receiving: a first microphone signal from a first microphone of a two-microphone array, and a second microphone signal from a second microphone of the two-microphone array; and
performing adaptive null beamforming on the first and second microphone signals, including:
decomposing the first microphone signal and the second microphone signal into a plurality of subbands;
at an initial time interval of a plurality of time intervals, evaluating a set of beamforming weights to be provided to each of the plurality of subbands, based, at least in part, on a direction of arrival of a target audio signal and a distance of the target signal from the first microphone and the second microphone, wherein each beamforming weight of the set of beamforming weights is a complex number;
for each time interval in the plurality of time intervals after the initial time interval, adaptively updating each beamforming weight of the set of beamforming weights to be provided to each of the plurality of subbands, based, at least in part, on a direction of arrival of a target audio signal and a distance of the target audio signal from the first microphone and the second microphone as evaluated based, at least in part, from the first and second microphone signals; and
for each time interval in the plurality of time intervals:
for each subband of the plurality of subbands, applying the set of beamforming weights; and
combining each subband of the plurality of subbands to provide an output signal.

2. The method of claim 1, further comprising performing noise cancellation by employing the output signal as a noise reference, wherein the target audio signal includes a speech signal.

3. The method of claim 1, wherein decomposing the first microphone signal and the second microphone signal into a plurality of subbands is accomplished with analysis filter banks.

4. The method of claim 1, wherein combining each subband of the plurality of subbands to provide an output signal is accomplished with a synthesis filter bank.

5. The method of claim 1, wherein adaptively updating each beamforming weight of the set of beamforming weights is accomplished based in part on a step-size parameter.

6. The method of claim 5, further comprising:
for each time interval in the plurality of time intervals, adaptively updating the step-size parameter such that the step-size parameter is proportional to a ratio of a power of the target audio signal to a microphone signal power.

7. The method of claim 1, wherein adaptively updating each beamforming weight of the set of beamforming weights is based on the direction of arrival of the target audio signal and a degradation factor, wherein the degradation factor is based, at least in part, on the distance of the target audio signal from the first microphone and the second microphone.

8. The method of claim 7, wherein adaptively updating each beamforming weight of the set of beamforming weights further includes adaptively updating a power normalization factor at each time interval after the first time interval of the plurality of time intervals.

9. The method of claim 7, wherein adaptively updating each beamforming weight of the set of beamforming weights is accomplished by minimizing a normalized output power.

10. The method of claim 7, wherein adaptively updating each beamforming weight of the set of beamforming weights is accomplished by employing a steepest descent algorithm.

11. An apparatus, comprising:
a memory that is configured to store code; and
at least one processor that is configured to execute the code to enable actions, including:
performing adaptive null beamforming on the first and second microphone signals, including:
receiving: a first microphone signal from a first microphone of a two-microphone array, and a second microphone signal from a second microphone of the two-microphone array;
decomposing the first microphone signal and the second microphone signal into a plurality of subbands;
at an initial time interval of a plurality of time intervals, evaluating a set of beamforming weights to be provided to each of the plurality of subbands, based at least in part on a direction of arrival of a target audio signal and a distance of the target signal from the first microphone and the second microphone, wherein each beamforming weight of the plurality of beamforming weights is a complex number;
for each time interval in the plurality of time intervals after the initial time interval, adaptively updating each of beamforming weight of the set of beamforming weights to be provided to each of the plurality of subbands, based at least in part on a direction of arrival of a target audio signal and a distance of the target audio signal from the first microphone and the second microphone as evaluated based, at least in part, from the first and second microphone signals; and
for each time interval in the plurality of time intervals:
for each subband of the plurality of subbands, applying the set of beamforming weights; and
combining each subband of the plurality of subbands to provide an output signal.

12. The apparatus of claim 11, wherein the processor is further configured such that adaptively updating each beamforming weight of the set of beamforming weights is accomplished based in part on a step-size parameter.

13. The apparatus of claim 11, wherein the processor is further configured such that adaptively updating each beamforming weight of the set of beamforming weights is based on the direction of arrival of the target audio signal and a degradation factor, wherein the degradation factor is based, at least in part, on the distance of the target audio signal from the first microphone and the second microphone.

14. The apparatus of claim 13, wherein the processor is further configured such that adaptively updating each beamforming weight of the set of beamforming weights is accomplished by minimizing a normalized output power.

15. The apparatus of claim 13, wherein the processor is further configured such that adaptively updating each beamforming weight of the set of beamforming weights is accomplished by employing a steepest descent algorithm.

16. A tangible processor-readable storage medium that arranged to encode processor-readable code, which, when executed by one or more processors, enables actions, comprising:
receiving: a first microphone signal from a first microphone of a two-microphone array, and a second microphone signal from a second microphone of the two-microphone array;
performing adaptive null beamforming on the first and second microphone signals, including:
decomposing the first microphone signal and the second microphone signal into a plurality of subbands;
at an initial time interval of a plurality of time intervals, evaluating a set of beamforming weights to be provided to each of the plurality of subbands, based at least in part on a direction of arrival of a target audio signal and a distance of the target signal from the first microphone and the second microphone, wherein each beamforming weight of the plurality of beamforming weights is a complex number;
for each time interval in the plurality of time intervals after the initial time interval, adaptively updating each of beamforming weight of the set of beamforming weights to be provided to each of the plurality of subbands, based at least in part on a direction of arrival of a target audio signal and a distance of the target audio signal from the first microphone and the second microphone as evaluated based, at least in part, from the first and second microphone signals; and
for each time interval in the plurality of time intervals:
for each subband of the plurality of subbands, applying the set of beamforming weights; and
combining each subband of the plurality of subbands to provide an output signal.

17. The tangible processor-readable storage medium of claim 16, wherein adaptively updating each beamforming weight of the set of beamforming weights is accomplished based in part on a step-size parameter.

18. The tangible processor-readable storage medium of claim 16, wherein adaptively updating each beamforming weight of the set of beamforming weights is based on the direction of arrival of the target audio signal and a degradation factor, wherein the degradation factor is based, at least in part, on the distance of the target audio signal from the first microphone and the second microphone.

19. The tangible processor-readable storage medium of claim 18, wherein adaptively updating each beamforming weight of the set of beamforming weights is accomplished by minimizing a normalized output power.

20. The tangible processor-readable storage medium of claim 18, wherein adaptively updating each beamforming weight of the set of beamforming weights is accomplished by employing a steepest descent algorithm.
